(19) United States
(12) Patent Application Publication
(10) Pub. No.: US 2020/0204986 A1
(43) Pub. Date: Jun. 25, 2020

(54) Uplink Data Compression In Mobile Communications

(71) Applicant: MediaTek Inc., Hsinchu City (TW)

(72) Inventors: Yung-Hsiang Liu, Hsinchu City (TW); Yih-Shen Chen, Hsinchu City (TW)

(21) Appl. No.: 16/720,509

(22) Filed: Dec. 19, 2019

Related U.S. Application Data
(60) Provisional application No. 62/783,241, filed on Dec. 21, 2018.

(51) Int. Cl. H04W 12/00; H04W 80/12; H04W 12/10; H04W 28/06; H04L 9/32

(52) U.S. Cl. CPC H04W 12/0013; H04W 80/12; H04L 9/3242; H04W 28/06; H04W 12/1006

(57) ABSTRACT

Various examples and schemes pertaining to uplink data compression (UDC) in mobile communications are described. A processor of an apparatus receives a Packet Data Convergence Protocol (PDCP) Session Data Unit (SDU) and performs uplink data compression (UDC) to compress a data portion of the PDCP SDU to generate a UDC packet. The processor also generates a message authentication code with integrity (MAC-I). The processor also ciphers at least a data portion of the UDC packet to provide a ciphered UDC packet. In case the PDCP SDU contains a Service Data Application Protocol (SDAP) header, the processor extracts the SDAP header from the PDCP SDU prior to performing the UDC, and the processor prepends the SDAP header to the ciphered UDC packet. The processor further constructs a PDCP Protocol Data Unit (PDU) by prepending a PDCP header to either the SDAP header or the ciphered UDC packet.

### CROSS REFERENCE TO RELATED PATENT APPLICATION(S)

The present disclosure is part of a non-provisional application claiming the priority benefit of U.S. Patent Application No. 62/783,241, filed on 21 Dec. 2018, the content of which being incorporated by reference in its entirety.

### TECHNICAL FIELD

The present disclosure is generally related to mobile communications and, more particularly, to techniques pertaining to uplink data compression in mobile communications.

### BACKGROUND

Unless otherwise indicated herein, approaches described in this section are not prior art to the claims listed below and are not admitted as prior art by inclusion in this section.

Uplink data compression (UDC) is specified in Release 15 (Rel-15) of the 3^{rd} Generation Partnership Project (3GPP) specification for Long-Term Evolution (LTE) Packet Data Convergence Protocol (PDCP) to improve uplink (UL) capacity and coverage. As technologies of mobile communications progress from the 4^{th} Generation (4G) LTE to 5^{th} Generation (5G) New Radio (NR), however, some of the problems encountered in LTE may likely to exist in NR. For example, UL coverage is limited by user equipment (UE) transmit (Tx) power, which is bounded by regulations. Additionally, there is still shortage of UL resources, or capacity, given that mobile internet users are content producers and that increasing downlink (DL) traffic tends to lead to more UL traffic. Moreover, UL transmission is vulnerable to poor radio condition, given that UL interference increases as the number of UEs increases and that current method(s) to extend UL coverage (e.g., PDCP repetition) is not suitable for latency-sensitive applications.

As both LTE and NR are radio access technologies for carrying data of upper layers, the concept of UDC is radio access network (RAN)-agnostic. Conceptually, UDC provides the same functionality in LTE and NR. With proper modification, UDC can be applied in NR as well. In addition, the size of UE capability becomes too large to fit in the PDCP Session Data Unit (SDU) size limitation of 9,000 bytes. UDC can also be applied to Radio Resource Control (RRC) messages for size reduction (e.g., applied to signaling radio bearer (SRB)). In NR, the PDCP layer provides its services to the RRC or Service Data Application Protocol (SDAP) layers. Thus, SDAP layer is added above the PDCP layer (e.g., the data from upper layer to NR PDCP may additionally include the SDAP header). Accordingly, an NR UDC mechanism needs to deal with SDAP.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is propose various concepts, solutions, schemes, techniques, designs and methods to address one or more, if not all, of aforementioned issues. In particular, the present disclosure proposes various schemes pertaining to UDC in mobile communications such as NR mobile communications.

In one aspect, a method may involve receiving a PDCP SDU and performing UDC to compress a data portion of the PDCP SDU to generate a UDC packet. The method may also involve generating a message authentication code with integrity (MAC-I) and ciphering at least a data portion of the UDC packet. The method may further involve constructing a PDCP Protocol Data Unit (PDU) that comprises, in a sequence, a PDCP header followed by the UDC packet.

In one aspect, an apparatus may include a processor. The processor may receive a PDCP SDU and perform UDC to compress a data portion of the PDCP SDU to generate a UDC packet. The processor may also generate a message authentication code with integrity (MAC-I) and cipher at least a data portion of the UDC packet. The processor may further construct a PDCP Protocol Data Unit (PDU) that comprises, in a sequence, a PDCP header followed by the UDC packet.

It is noteworthy that, although description provided herein may be in the context of certain radio access technologies, networks and network topologies such as 5G/NR, the proposed concepts, schemes and any variation(s)/derivative(s) thereof may be implemented in, for and by other types of radio access technologies, networks and network topologies such as, for example and without limitation, LTE, LTE-Advanced, LTE-Advanced Pro, narrowband (NB), narrowband Internet of Things (NB-IoT), Wi-Fi and any future-developed networking and communication technologies. It is also noteworthy that, in the present disclosure, UDC is merely an example framework for UL data compression and is not bound to or otherwise associated with a specific compression algorithm. For instance, DEFLATE (IEEE RFC 1951) is one of some of the possible compression algorithm options. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram of an example network environment in which various solutions and schemes in accordance with the present disclosure may be implemented.

FIG. 2 is a diagram of an example NR PDCP processing flow in accordance with an implementation of the present disclosure.

FIG. 3 is a diagram of an example PDCP header format in accordance with an implementation of the present disclosure.

FIG. 4 is a diagram of an example PDCP header format in accordance with an implementation of the present disclosure.

FIG. 5 is a diagram of an example PDCP header format in accordance with an implementation of the present disclosure.

FIG. 6 is a block diagram of an example communication system in accordance with an implementation of the present disclosure.

FIG. 7 is a flowchart of an example process in accordance with an implementation of the present disclosure.

FIG. 8 is a flowchart of an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to UDC in mobile communications. According to the present disclosure, a number of possible solutions may be implemented separately or jointly. That is, although these possible solutions may be described below separately, two or more of these possible solutions may be implemented in one combination or another.

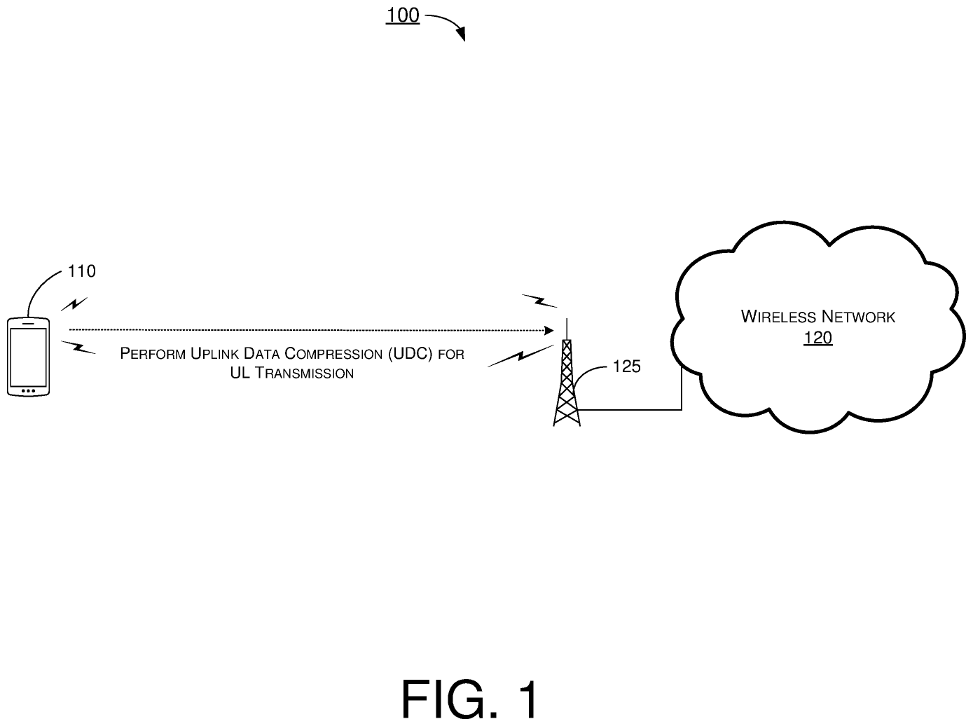

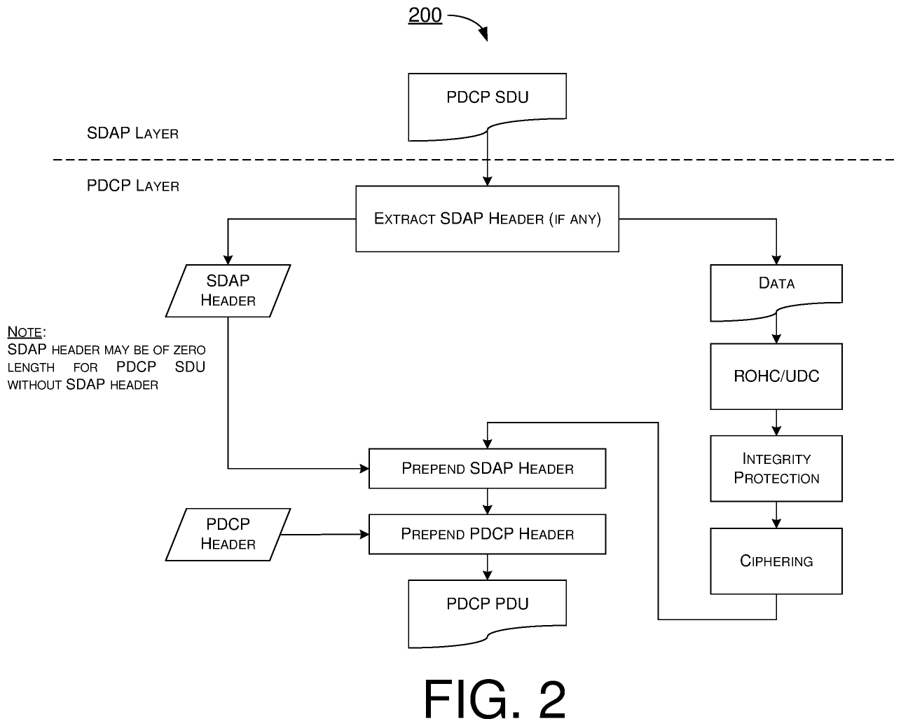

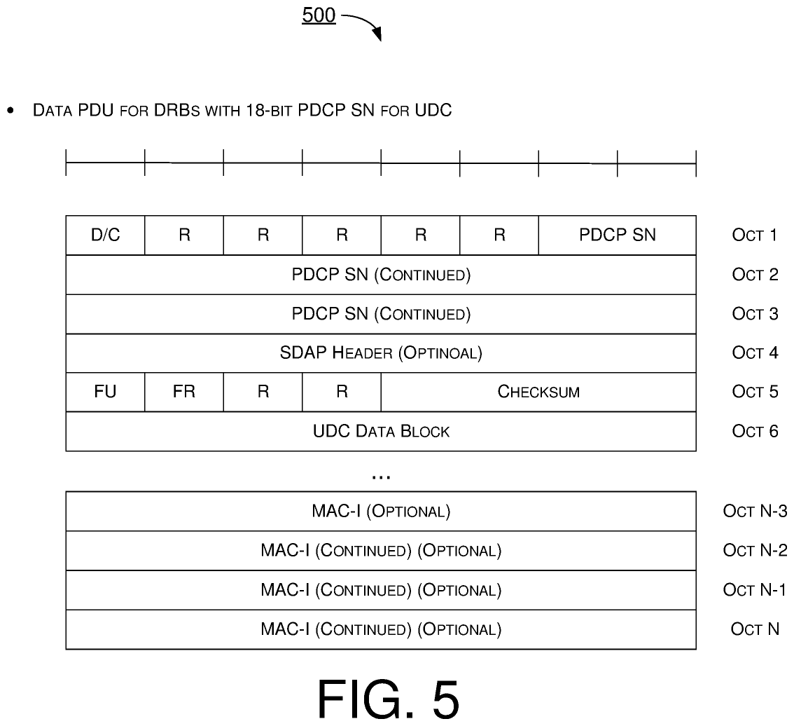

FIG. 1 illustrates an example network environment 100 in which various solutions and schemes in accordance with the present disclosure may be implemented. FIG. 2˜FIG. 5 illustrate example NR PDCP processing flow 200 and example PDCP header formats 300, 400 and 500, respectively, in accordance with implementations of the present disclosure. Each of NR PDCP processing flow 200 and PDCP header formats 300, 400 and 500 may be implemented in network environment 100. The following description of various proposed schemes is provided with reference to FIG. 1˜FIG. 5.

Referring to FIG. 1, network environment 100 may involve a UE 110 in wireless communication with a wireless network 120 (e.g., a 5G NR mobile network). UE 110 may initially be in wireless communication with wireless network 120 via a base station or network node 125 (e.g., an eNB, gNB or transmit-receive point (TRP)). In network environment 100, UE 110 and wireless network 120 may implement various schemes pertaining to UDC in mobile communications in accordance with the present disclosure, as described herein. For instance, UE 110 may perform UDC in accordance with one or more proposed schemes in accordance with the present disclosure for UL transmissions to network node 125 of wireless network 120.

Since SDAP is mainly relevant to quality of service (QoS) handling, there may be several ways to speed up routing under proposed schemes in accordance with the present disclosure. For instance, under various proposed schemes, SDAP may be excluded from one or more of UDC processing, robust header compression (ROHC) processing, and ciphering. Various example implementations are described below.

FIG. 2 illustrates an example NR PDCP processing flow 200 in accordance with an implementation of the present disclosure. Under a proposed scheme in accordance with the present disclosure, from the perspective of UE 110, NR PDCP may process an upper-layer packet following processing flow 200. Referring to FIG. 2, in the PDCP layer, a packet may be received from an upper layer (e.g., RRC layer or SDAP layer). In case that any SDAP header exists in the packet, the SDAP header may be extracted from the received packet. Depending on the configuration of the packet, ROHC, UL-ROHC and/or UDC may then be performed on the remaining part of the packet. Additionally, depending on the configuration of the packet, integrity protection may be performed. Then, ciphering may be performed. Next, in case that an SDAP header exists, the SDAP header and the ciphered result may be concatenated together (e.g., by prepending the SDAP header to the ciphered result) before prepending a PDCP header thereto.

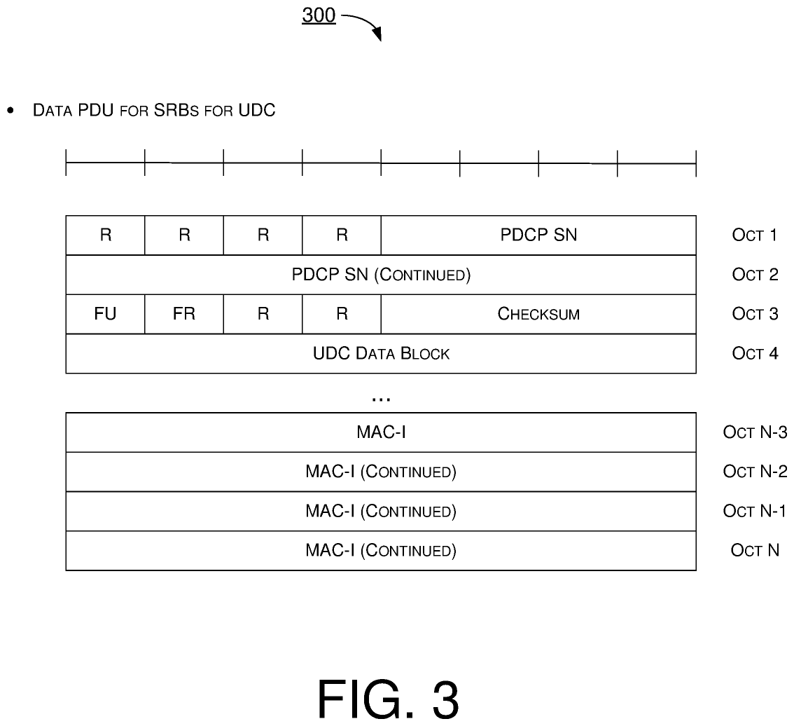

FIG. 3˜FIG. 5 illustrate an example PDCP header format 300, 400 and 500, respectively, in accordance with an implementation of the present disclosure. In UDC protocol, a UDC header may be designed to carry some information about UDC function for consistent processing between a sender and a receiver and for error detection. The UDC header may be added in UDC compression function followed by UDC data block. By using the UDC processing flow, the PDCP Protocol Data Unit (PDU) may include the following components: PDCP header, SDAP header (if configured in data radio bearer (DRB)), UDC header, UDC data block, and a message authentication code with integrity (MAC-I) if configured.

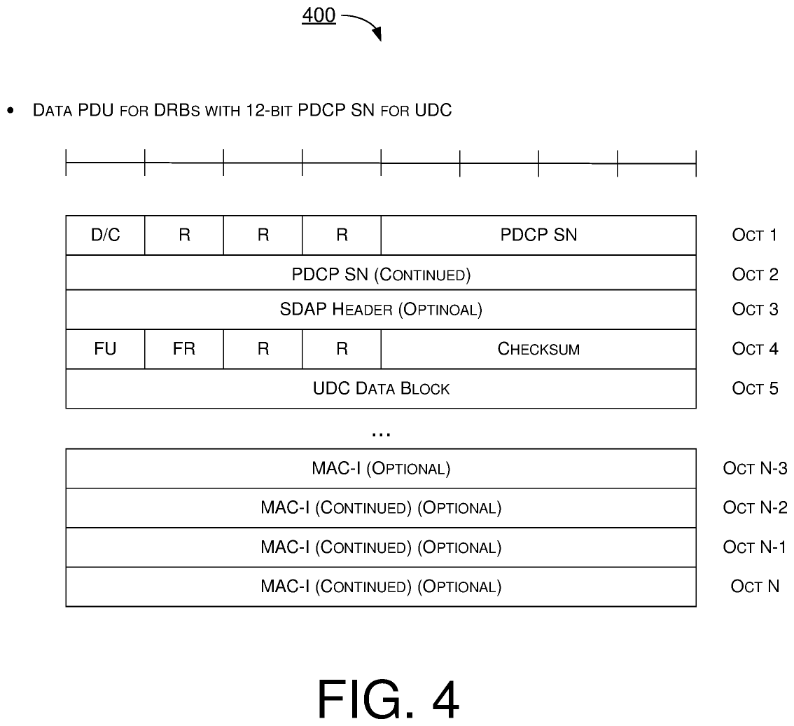

Referring to FIG. 3, PDCP header format 300 may be composed of a plurality of bytes or octets (shown as Oct 1˜Oct N in FIG. 3), and PDCP header format 300 may include data PDU for SRBs for UDC. Referring to FIG. 4, PDCP header format 400 may be composed of a plurality of bytes or octets (shown as Oct 1˜Oct N in FIG. 4), and PDCP header format 400 may include data PDU for DRBs with 12 bits of PDCP sequence number (SN) for UDC. Referring to FIG. 5, PDCP header format 500 may be composed of a plurality of bytes or octets (shown as Oct 1˜Oct N in FIG. 5), and PDCP header format 500 may include data PDU for DRBs with 18 bits of PDCP SN for UDC.

Under a proposed scheme in accordance with the present disclosure, with respect to SRB in the context of NR UDC processing flow (e.g., processing flow 200), an NR PDCP entity may be configured with UDC and, when the NR PDCP entity receives a PDCP session data unit (SDU) from RRC, the PDCP entity may perform certain operations to construct a PDCU PDU. For instance, the PDCP entity may perform UDC on the PDCP SDU to obtain a UDC packet that includes a UDC header and a UDC data block. Additionally, the PDCP entity may perform integrity protection on the UDC packet. Moreover, the PDCP entity may cipher the UDC packet and MAC-I. Furthermore, the PDCP entity may prepend a PDCP header to the ciphered octets.

Under a proposed scheme in accordance with the present disclosure, with respect to DRB without an SDAP header in the context of NR UDC processing flow (e.g., processing flow 200), an NR PDCP entity may be configured with UDC and, when the NR PDCP entity receives a PDCP SDU from SDAP without the SDAP header, the PDCP entity may perform certain operations to construct a PDCP PDU. For instance, the PDCP entity may perform UDC on the PDCP SDU to obtain a UDC packet that includes a UDC header and a UDC data block. Additionally, the PDCP entity may perform integrity protection on the UDC packet if configured. Moreover, the PDCP entity may cipher the UDC packet and MAC-I if configured. Furthermore, the PDCP entity may prepend a PDCP header to the ciphered octets.

Under a proposed scheme in accordance with the present disclosure, with respect to DRB with an SDAP header in the context of NR UDC processing flow (e.g., processing flow 200), an NR PDCP entity may be configured with UDC and, when the NR PDCP entity receives a PDCP SDU from SDAP with the SDAP header, the PDCP entity may perform certain operations to construct a PDCP PDU. For instance, the PDCP entity may extract the SDAP header from the PDCP SDU (which includes the SDAP header and data). The PDCP entity may then perform UDC on the data portion of the PDCP SDU to obtain a UDC packet that includes a UDC header and a UDC data block. Additionally, the PDCP entity may perform integrity protection on the UDC packet if configured. Moreover, the PDCP entity may cipher the UDC packet and MAC-I, if integrity protection is configured. Next, the PDCP entity may prepend the extracted SDASP header to the ciphered octets. Furthermore, the PDCP entity may prepend a PDCP header to the SDAP header.

Under a proposed scheme in accordance with the present disclosure, with respect to DRB in SDAP/PDCP one-layer design in the context of NR UDC processing flow (e.g., processing flow 200), an NR PDCP entity may be configured with UDC while NR SDAP and NR PDCP may be implemented in a single layer (herein interchangeably denoted as “SDAP/PDCP” and “NR SDAP/PDCP”). When NR SDAP/PDCP receives an SDAP SDU, the NR SDAP/PDCP may perform certain operations to construct a PDCP PDU. For instance, the SDAP/PDCP may perform UDC on the SDAP SDU to obtain a UDC packet that includes a UDC header and a UDC data block. Additionally, the SDAP/PDCP may perform integrity protection on the UDC packet if configured. Moreover, the SDAP/PDCP may cipher the UDC packet and MAC-I, if integrity protection is configured. Next, the PDCP entity may prepend an SDASP header to the ciphered octets if configured. Furthermore, the PDCP entity may prepend a PDCP header to the resultant octets from above operations.

### Illustrative Implementations

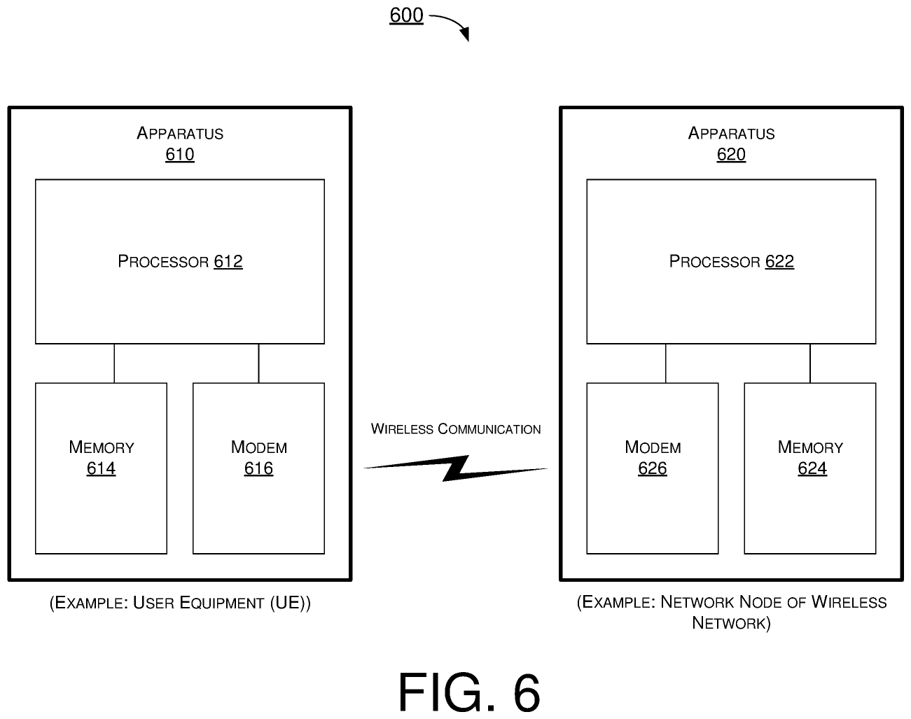

FIG. 6 illustrates an example communication system 600 having an example apparatus 610 and an example apparatus 620 in accordance with an implementation of the present disclosure. Each of apparatus 610 and apparatus 620 may perform various functions to implement schemes, techniques, processes and methods described herein pertaining to UDC in mobile communications, including various schemes described above as well as processes described below.

Each of apparatus 610 and apparatus 620 may be a part of an electronic apparatus, which may be a UE such as a vehicle, a portable or mobile apparatus, a wearable apparatus, a wireless communication apparatus or a computing apparatus. For instance, each of apparatus 610 and apparatus 620 may be implemented in an electronic control unit (ECU) of a vehicle, a smartphone, a smartwatch, a personal digital assistant, a digital camera, or a computing equipment such as a tablet computer, a laptop computer or a notebook computer. Each of apparatus 610 and apparatus 620 may also be a part of a machine type apparatus, which may be an IoT or NB-IoT apparatus such as an immobile or a stationary apparatus, a home apparatus, a wire communication apparatus or a computing apparatus. For instance, each of apparatus 610 and apparatus 620 may be implemented in a smart thermostat, a smart fridge, a smart door lock, a wireless speaker or a home control center. Alternatively, each of apparatus 610 and apparatus 620 may be implemented in the form of one or more integrated-circuit (IC) chips such as, for example and without limitation, one or more single-core processors, one or more multi-core processors, one or more complex-instruction-set-computing (CISC) processors, or one or more reduced-instruction-set-computing (RISC) processors. Each of apparatus 610 and apparatus 620 may include at least some of those components shown in FIG. 6 such as a processor 612 and a processor 622, respectively. Each of apparatus 610 and apparatus 620 may further include one or more other components not pertinent to the proposed scheme of the present disclosure (e.g., internal power supply, display device and/or user interface device), and, thus, such component(s) of each of apparatus 610 and apparatus 620 are neither shown in FIG. 6 nor described below in the interest of simplicity and brevity.

In some implementations, at least one of apparatus 610 and apparatus 620 may be a part of an electronic apparatus, which may be a vehicle, a roadside unit (RSU), network node or base station (e.g., eNB, gNB or TRP), a small cell, a router or a gateway. For instance, at least one of apparatus 610 and apparatus 620 may be implemented in a vehicle in a vehicle-to-vehicle (V2V) or vehicle-to-everything (V2X) network, an eNodeB in an LTE, LTE-Advanced or LTE-Advanced Pro network or in a gNB in a 5G, NR, IoT or NB-IoT network. Alternatively, at least one of apparatus 610 and apparatus 620 may be implemented in the form of one or more IC chips such as, for example and without limitation, one or more single-core processors, one or more multi-core processors, or one or more CISC or RISC processors.

In one aspect, each of processor 612 and processor 622 may be implemented in the form of one or more single-core processors, one or more multi-core processors, or one or more CISC or RISC processors. That is, even though a singular term “a processor” is used herein to refer to processor 612 and processor 622, each of processor 612 and processor 622 may include multiple processors in some implementations and a single processor in other implementations in accordance with the present disclosure. In another aspect, each of processor 612 and processor 622 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 612 and processor 622 is a special-purpose machine specifically designed, arranged and configured to perform specific tasks including UDC in mobile communications in accordance with various implementations of the present disclosure.

In some implementations, apparatus 610 may also include a wireless transceiver 616 coupled to processor 612 and capable of wirelessly transmitting and receiving data over a wireless link (e.g., a 3GPP connection or a non-3GPP connection). In some implementations, apparatus 610 may further include a memory 614 coupled to processor 612 and capable of being accessed by processor 612 and storing data therein. In some implementations, apparatus 620 may also include a wireless transceiver 626 coupled to processor 622 and capable of wirelessly transmitting and receiving data over a wireless link (e.g., a 3GPP connection or a non-3GPP connection). In some implementations, apparatus 620 may further include a memory 624 coupled to processor 622 and capable of being accessed by processor 622 and storing data therein. Accordingly, apparatus 610 and apparatus 620 may wirelessly communicate with each other via transceiver 616 and transceiver 626, respectively.

To aid better understanding, the following description of the operations, functionalities and capabilities of each of apparatus 610 and apparatus 620 is provided in the context of an NR communication environment in which apparatus 610 is implemented in or as a wireless communication device, a communication apparatus, a UE or an IoT device (e.g., UE 110) and apparatus 620 is implemented in or as a base station or network node (e.g., network node 125).

In one aspect of UDC in mobile communications in accordance with the present disclosure, processor 612 of apparatus 610 may receive a PDCP SDU (e.g., from an upper layer such as SDAP layer). Additionally, processor 612 may perform UDC to compress a data portion of the PDCP SDU (e.g., SDAP header is precluded from compression) to generate a UDC packet. Moreover, processor 612 may generate a MAC-I as well as cipher at least a data portion of the UDC packet to provide a ciphered UDC packet. In an event that the PDCP SDU contains an SDAP header, processor 612 may extract the SDAP header from the PDCP SDU prior to performing the UDC to compress the data portion of the PDCP SDU and prepend the SDAP header to the ciphered UDC packet. Furthermore, processor 612 may construct a PDCP PDU by prepending a PDCP header to either (1) the SDAP header, in response to the PDCP SDU containing the SDAP header, or (2) the ciphered UDC packet, in response to the PDCP SDU not containing the SDAP header.

In some implementations, the PDCP PDU may further include the MAC-I.

In some implementations, in generating the MAC-I, process 700 may involve processor 612 performing integrity protection on the UDC packet.

In some implementations, in ciphering, process 700 may further involve processor 612 ciphering the MAC-I.

In some implementations, in ciphering, process 700 may further involve processor 612 ciphering a UDC header of the UDC packet.

In some implementations, the UDC packet may include a UDC header and a UDC data block. In such cases, the UDC header may be followed by the UDC data block.

In some implementations, in constructing the PDCP PDU, process 700 may further involve processor 612 constructing the PDCP PDU for a data radio bearer (DRB) such that the PDCP PDU comprises, in a sequence, the PDCP header, which is optionally followed by the SDAP header, which is followed by the UDC header, which is followed by the UDC data block, which is optionally followed by the MAC-I.

In another aspect of UDC in mobile communications in accordance with the present disclosure, processor 612 of apparatus 610 may receive a PDCP SDU (e.g., from an upper layer such as SDAP layer) and perform UDC to compress a data portion of the PDCP SDU (e.g., SDAP header is precluded from compression) to generate a UDC packet. Additionally, processor 612 may generate a MAC-I. Moreover, processor 612 ciphering at least a data portion of the UDC packet. Furthermore, processor 612 may construct a PDCP PDU comprising, in a sequence, a PDCP header followed by the UDC packet. In some implementations, the UDC packet may include a UDC header and a UDC data block. In some implementations, the UDC header may be followed by the UDC data block. In such cases, in constructing the PDCP PDU, process 700 may involve processor 612 constructing the PDCP PDU for a DRB such that the PDCP PDU comprises, in a sequence, the PDCP header, which is optionally followed by an SDAP header, which is followed by the UDC header, which is followed by the UDC data block, which is optionally followed by the MAC-I.

In some implementations, the PDCP PDU may further comprise at least one of an SDAP header and the MAC-I.

In some implementations, in generating the MAC-I, processor 612 may also perform integrity protection on the UDC packet.

In some implementations, in ciphering, processor 612 may also cipher the MAC-I.

In some implementations, in ciphering, processor 612 may cipher a UDC header of the UDC packet.

In some implementations, processor 612 may also determine whether the PDCP SDU contains an SDAP header. In such cases, in an event that the PDCP SDU contains the SDAP header, the SDAP header may not be compressed by the UDC.

### Illustrative Processes

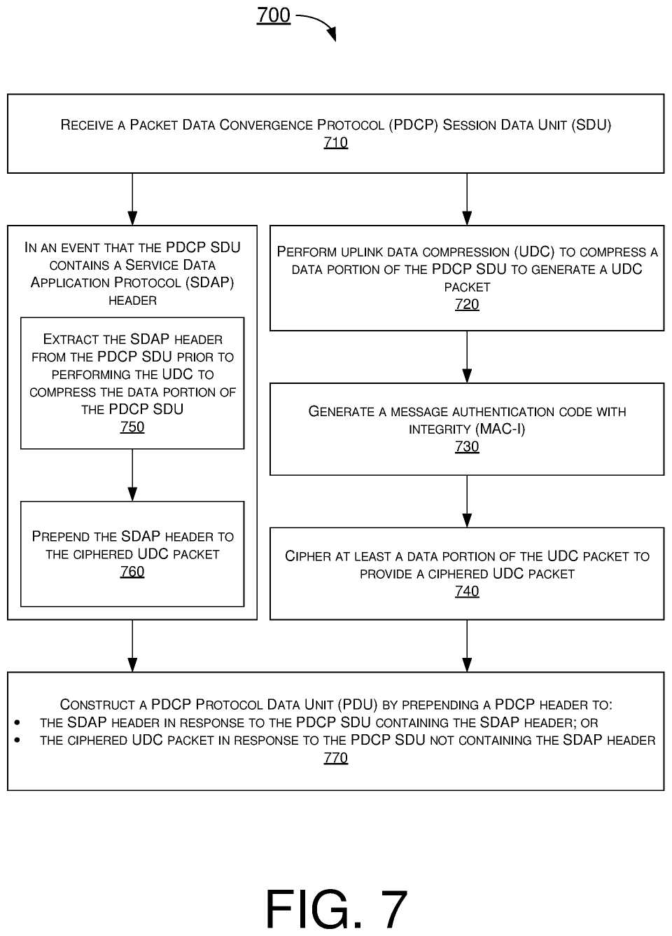

FIG. 7 illustrates an example process 700 in accordance with an implementation of the present disclosure. Process 700 may be an example implementation of the proposed schemes described above with respect to UDC in mobile communications in accordance with the present disclosure. Process 700 may represent an aspect of implementation of features of apparatus 610 and apparatus 620. Process 700 may include one or more operations, actions, or functions as illustrated by one or more of blocks 710, 720, 730, 740, 750, 760 and 770. Although illustrated as discrete blocks, various blocks of process 700 may be divided into additional blocks, combined into fewer blocks, or eliminated, depending on the desired implementation. Moreover, the blocks of process 700 may be executed in the order shown in FIG. 7 or, alternatively, in a different order. Process 700 may also be repeated partially or entirely. Process 700 may be implemented by apparatus 610, apparatus 620 and/or any suitable wireless communication device, UE, RSU, base station or machine type devices. Solely for illustrative purposes and without limitation, process 700 is described below in the context of apparatus 610 as UE 110 and apparatus 620 as network node 125. Process 700 may begin at block 710.

At 710, process 700 may involve processor 612 of apparatus 610 receiving a PDCP SDU (e.g., from an upper layer such as SDAP layer). Process 700 may proceed from 710 to 720 and, optionally, also from 710 to 750.

At 720, process 700 may involve processor 612 performing UDC to compress a data portion of the PDCP SDU (e.g., SDAP header is precluded from compression) to generate a UDC packet. Process 700 may proceed from 720 to 730.

At 730, process 700 may involve processor 612 generating a MAC-I. Process 700 may proceed from 730 to 740.

At 740, process 700 may involve processor 612 ciphering at least a data portion of the UDC packet to provide a ciphered UDC packet. Process 700 may proceed from 740 to 770.

At 750, in an event that the PDCP SDU contains an SDAP header, process 700 may involve processor 612 extracting the SDAP header from the PDCP SDU prior to performing the UDC to compress the data portion of the PDCP SDU. Process 700 may proceed from 750 to 760.

At 760, in an event that the PDCP SDU contains an SDAP header, process 700 may further involve processor 612 prepending the SDAP header to the ciphered UDC packet. Process 700 may proceed from 760 to 770.

At 770, process 700 may involve processor 612 constructing a PDCP PDU by prepending a PDCP header to either (1) the SDAP header, in response to the PDCP SDU containing the SDAP header, or (2) the ciphered UDC packet, in response to the PDCP SDU not containing the SDAP header.

In some implementations, the PDCP PDU may further include the MAC-I.

In some implementations, in generating the MAC-I, process 700 may involve processor 612 performing integrity protection on the UDC packet.

In some implementations, in ciphering, process 700 may further involve processor 612 ciphering the MAC-I.

In some implementations, in ciphering, process 700 may further involve processor 612 ciphering a UDC header of the UDC packet.

In some implementations, the UDC packet may include a UDC header and a UDC data block. In such cases, the UDC header may be followed by the UDC data block.

In some implementations, in constructing the PDCP PDU, process 700 may further involve processor 612 constructing the PDCP PDU for a DRB such that the PDCP PDU comprises, in a sequence, the PDCP header, which is optionally followed by the SDAP header, which is followed by the UDC header, which is followed by the UDC data block, which is optionally followed by the MAC-I.

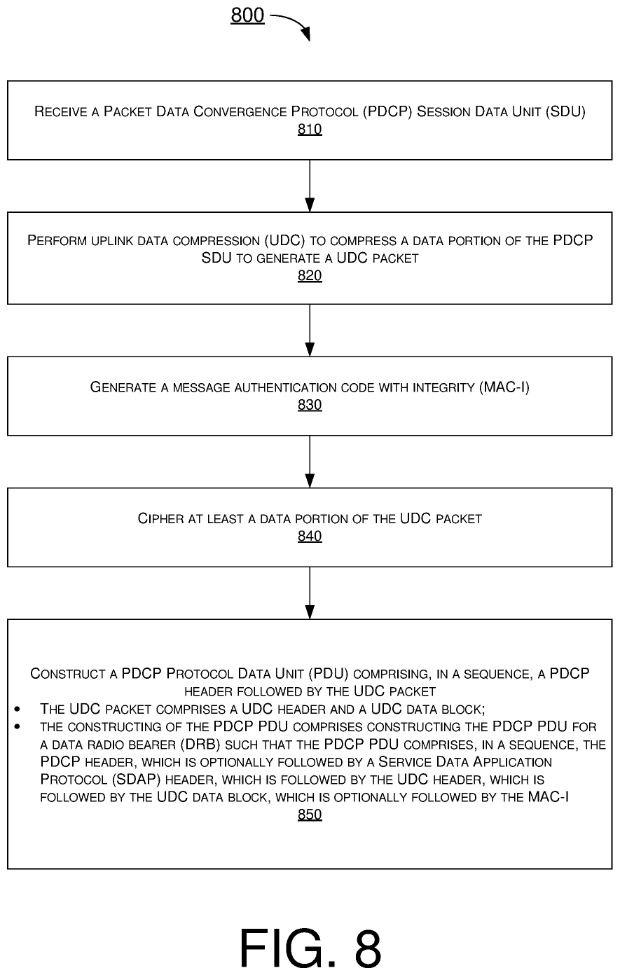

FIG. 8 illustrates an example process 800 in accordance with an implementation of the present disclosure. Process 800 may be an example implementation of the proposed schemes described above with respect to UDC in mobile communications in accordance with the present disclosure. Process 800 may represent an aspect of implementation of features of apparatus 610 and apparatus 620. Process 800 may include one or more operations, actions, or functions as illustrated by one or more of blocks 810, 820, 830, 840 and 850. Although illustrated as discrete blocks, various blocks of process 800 may be divided into additional blocks, combined into fewer blocks, or eliminated, depending on the desired implementation. Moreover, the blocks of process 800 may be executed in the order shown in FIG. 8 or, alternatively, in a different order. Process 800 may also be repeated partially or entirely. Process 800 may be implemented by apparatus 610, apparatus 620 and/or any suitable wireless communication device, UE, RSU, base station or machine type devices. Solely for illustrative purposes and without limitation, process 800 is described below in the context of apparatus 610 as UE 110 and apparatus 620 as network node 125. Process 800 may begin at block 810.

At 810, process 800 may involve processor 612 of apparatus 610 receiving a PDCP SDU (e.g., from an upper layer such as SDAP layer). Process 800 may proceed from 810 to 820.

At 820, process 800 may involve processor 612 performing UDC to compress a data portion of the PDCP SDU (e.g., SDAP header is precluded from compression) to generate a UDC packet. Process 800 may proceed from 820 to 830.

At 830, process 800 may involve processor 612 generating a MAC-I. Process 800 may proceed from 830 to 840.

At 840, process 800 may involve processor 612 ciphering at least a data portion of the UDC packet. Process 800 may proceed from 840 to 850.

At 850, process 800 may involve processor 612 constructing a PDCP PDU comprising, in a sequence, a PDCP header followed by the UDC packet. In some implementations, the UDC packet may include a UDC header and a UDC data block. In some implementations, the UDC header may be followed by the UDC data block. In such cases, in constructing the PDCP PDU, process 800 may involve processor 612 constructing the PDCP PDU for a DRB such that the PDCP PDU comprises, in a sequence, the PDCP header, which is optionally followed by an SDAP header, which is followed by the UDC header, which is followed by the UDC data block, which is optionally followed by the MAC-I.

In some implementations, the PDCP PDU may further comprise at least one of an SDAP header and the MAC-I.

In some implementations, in generating the MAC-I, process 800 may involve processor 612 performing integrity protection on the UDC packet.

In some implementations, in ciphering, process 800 may further involve processor 612 ciphering the MAC-I.

In some implementations, in ciphering, process 800 may further involve processor 612 ciphering a UDC header of the UDC packet.

In some implementations, process 800 may further involve processor 612 determining whether the PDCP SDU contains an SDAP header. In such cases, in an event that the PDCP SDU contains the SDAP header, the SDAP header may not be compressed by the UDC.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method implemented in an electronic apparatus, comprising:
receiving a Packet Data Convergence Protocol (PDCP) Session Data Unit (SDU);
performing uplink data compression (UDC) to compress a data portion of the PDCP SDU to generate a UDC packet;
generating a message authentication code with integrity (MAC-I);
ciphering at least a data portion of the UDC packet to provide a ciphered UDC packet;
in an event that the PDCP SDU contains a Service Data Application Protocol (SDAP) header:
extracting the SDAP header from the PDCP SDU prior to performing the UDC to compress the data portion of the PDCP SDU; and
prepending the SDAP header to the ciphered UDC packet; and
constructing a PDCP Protocol Data Unit (PDU) by prepending a PDCP header to:
the SDAP header responsive to the PDCP SDU containing the SDAP header; or
the ciphered UDC packet responsive to the PDCP SDU not containing the SDAP header.

2. The method of claim 1, wherein the PDCP PDU further comprises the MAC-I.

3. The method of claim 1, wherein the generating of the MAC-I comprises performing integrity protection on the UDC packet.

4. The method of claim 1, wherein the ciphering further comprises ciphering the MAC-I.

5. The method of claim 1, wherein the ciphering further comprises ciphering a UDC header of the UDC packet.

6. The method of claim 1, wherein the UDC packet comprises a UDC header and a UDC data block.

7. The method of claim 6, wherein the UDC header is followed by the UDC data block.

8. The method of claim 6, wherein the constructing of the PDCP PDU comprises constructing the PDCP PDU for a data radio bearer (DRB) such that the PDCP PDU comprises, in a sequence, the PDCP header, which is optionally followed by the SDAP header, which is followed by the UDC header, which is followed by the UDC data block, which is optionally followed by the MAC-I.

9. A method implemented in an electronic apparatus, comprising:
receiving a Packet Data Convergence Protocol (PDCP) Session Data Unit (SDU);
performing uplink data compression (UDC) to compress a data portion of the PDCP SDU to generate a UDC packet;
generating a message authentication code with integrity (MAC-I);
ciphering at least a data portion of the UDC packet; and
constructing a PDCP Protocol Data Unit (PDU) comprising, in a sequence, a PDCP header followed by the UDC packet,
wherein the UDC packet comprises a UDC header and a UDC data block, and
wherein the constructing of the PDCP PDU comprises constructing the PDCP PDU for a data radio bearer (DRB) such that the PDCP PDU comprises, in a sequence, the PDCP header, which is optionally followed by a Service Data Application Protocol (SDAP) header, which is followed by the UDC header, which is followed by the UDC data block, which is optionally followed by the MAC-I.

10. The method of claim 9, wherein the PDCP PDU further comprises at least one of a Service Data Application Protocol (SDAP) header and the MAC-I.

11. The method of claim 9, wherein the generating of the MAC-I comprises performing integrity protection on the UDC packet.

12. The method of claim 9, wherein the ciphering further comprises ciphering the MAC-I.

13. The method of claim 9, wherein the ciphering further comprises ciphering a UDC header of the UDC packet.

14. The method of claim 9, further comprising:
determining whether the PDCP SDU contains a Service Data Application Protocol (SDAP) header.

15. The method of claim 14, wherein, in an event that the PDCP SDU contains the SDAP header, the SDAP header is not compressed by the UDC.

16. The method of claim 9, wherein the UDC header is followed by the UDC data block.

17. An apparatus, comprising:
a processor which, during operation, performs tasks comprising:
receiving a Packet Data Convergence Protocol (PDCP) Session Data Unit (SDU);
performing uplink data compression (UDC) to compress a data portion of the PDCP SDU to generate a UDC packet;
generating a message authentication code with integrity (MAC-I);
ciphering at least a data portion of the UDC packet to provide a ciphered UDC packet;
in an event that the PDCP SDU contains a Service Data Application Protocol (SDAP) header:
extracting the SDAP header from the PDCP SDU prior to performing the UDC to compress the data portion of the PDCP SDU; and
prepending the SDAP header to the ciphered UDC packet;
and
constructing a PDCP Protocol Data Unit (PDU) by prepending a PDCP header to:
the SDAP header responsive to the PDCP SDU containing the SDAP header; or
the ciphered UDC packet responsive to the PDCP SDU not containing the SDAP header.

18. The apparatus of claim 17, wherein the PDCP PDU further comprises the MAC-I, and wherein, in generating the MAC-I, the processor performs integrity protection on the UDC packet.

19. The apparatus of claim 17, wherein, in ciphering, the processor further ciphers the MAC-I and a UDC header of the UDC packet.

20. The apparatus of claim 19, wherein the UDC packet comprises a UDC header and a UDC data block, and wherein, in constructing the PDCP PDU, the processor constructs the PDCP PDU for a data radio bearer (DRB) such that the PDCP PDU comprises, in a sequence, the PDCP header, which is optionally followed by the SDAP header, which is followed by the UDC header, which is followed by the UDC data block, which is optionally followed by the MAC-I.
